(19) United States
(12) Patent Application Publication
(10) Pub. No.: US 2015/0375474 A1
(43) Pub. Date: Dec. 31, 2015

(54) ENERGY ABSORBENT PADS FOR ATTACHMENT TO TEXTILES

(71) Applicants: Eric Degolier, Sussex (GB); Adam Turvey, Bartley Green (GB)

(72) Inventors: Eric Degolier, Sussex (GB); Adam Turvey, Bartley Green (GB)

(21) Appl. No.: 14/765,142

(22) PCT Filed: Jan. 31, 2014
(86) PCT No.: PCT/GB2014/050281

§ 371 Date: Jul. 31, 2015

(30) Foreign Application Priority Data
Feb. 1, 2013 (GB) 1301867.6

(51) Int. Cl. B32B 5/20; B32B 5/24; B32B 37/15; B32B 5/02; B32B 37/12; B32B 3/26; B32B 3/30

(52) U.S. Cl. CPC B32B 5/20; B32B 3/266; B32B 5/245; B32B 3/30; B32B 5/024; B32B 5/022; B32B 37/1207; B32B 37/15; B32B 2307/51; B32B 2307/31; B32B 2250/22; B32B 2437/00; B32B 2266/08; B32B 2307/56; B32B 2266/0278; B32B 2305/022; B32B 2305/18; B32B 2375/00

(57) ABSTRACT

There is provided a pad (17) for attachment to a textile by heating, the pad comprising a body (3) comprising an elastic, energy absorbent material, which exhibits a resistive load under deformation which increases with the rate of deformation, the body having a first surface (7) and an opposing second surface (21), and a layer of heat sensitive adhesive (5) at least partially covering the first surface of the body and being bonded to the first surface, at least at the periphery thereof, so that the pad may be attached to a textile by heating.

The present invention relates to pads for attachment to textiles by heating. In particular, the invention relates to elastic/energy absorbent pads that may be attached to textiles by a layer of heat sensitive adhesive, textile articles having such pads attached thereto, and kits for producing such textile articles.

There are numerous situations in which at least some degree of impact protection for the human or animal body may be advantageous. These range from work situations, in which uncontrolled falling or fast moving objects may be encountered, various sporting situations, in which falls and/or contact with various forms of equipment or other participants may occur, and also include combat situations.

Various materials have been developed for use in impact protection systems, and many conventional systems use, as the energy absorbent material, elastomeric foams or similar relatively soft, resiliently compressible materials. However, only limited protection is achieved thereby. In some systems, this energy absorbent material is employed in combination with a rigid member, the purpose of which is to spread the impact force over a greater area and therefore reduce its effect. However, such systems tend to be inflexible and uncomfortable if in contact with a human or animal body. More recently, impact protection materials based on the combination of foamed or unfoamed polymers and dilatant materials have been developed, see for example WO 03/055339 and WO 2005/000966.

In general, impact protection materials are not suitable for direct attachment to the human or animal body, and they are therefore normally attached to garments, or used as pads or patches with straps or sleeves for attachment to particular body parts. Conventional impact protection materials are difficult to attach directly to fabrics, and have generally been included in specially sewn pockets. However, the production of such pockets requires the use of extra fabric materials and increases machining/manufacturing time. In other cases, impact protection pads may be attached to fabrics by stitching, either through holes in the impact protection material itself or through skirts of material integrally formed with the pads. But again, this requires extra materials and machining/manufacturing time. Such pads are also difficult to remove if they become damaged, or if the article to which they are attached needs to be processed (for example, washed) under conditions that are not suitable for the impact protection pad. Conversely, should the stitching, or area that is stitched, become damaged, it may be difficult to prevent the pad becoming completely detached from the article. It is also difficult for domestic users to themselves attach pads to textiles by sewing.

US 2009/0255625 discloses cushioning members comprising foamed polymeric materials that may be stitched to fabric articles. In some instances the foam polymers may be adhered to various surfaces, but the adhesives must be supplied separately, and once the foamed materials have been attached to the fabric, they cannot be easily removed, for example for replacement or adjustment.

According to the present invention, there is provided a pad for attachment to a textile by heating, the pad comprising:

a body comprising an elastic, energy absorbent material, which exhibits a resistive load under deformation which increases with the rate of deformation,

the body having a first surface and an opposing second surface, and

a layer of heat sensitive adhesive at least partially covering the first surface of the body and being bonded to the first surface, at least at the periphery thereof,

so that the pad may be attached to a textile by heating.

The pads of the present invention may be easily and conveniently attached to textiles on an industrial scale, for example by use of a heat press, or by individual users, for example by ironing.

Any suitable elastic, energy absorbent material, which exhibits a resistive load under deformation which increases with the rate of deformation, may be used to form the body of a pad of the invention. Preferably, however, the elastic, energy absorbent material is a composite material which comprises i) a first polymer-based material and ii) a second polymer-based material, different from i), which exhibits dilatancy in the absence of i), wherein the second polymer-based material ii) is entrapped in a matrix of the first polymer-based material i), the composite material being unfoamed or foamed, and, when unfoamed being preparable by incorporating the second polymer-based material ii) with the first polymer-based material i) prior to formation of the matrix, and when foamed, being preparable by incorporating the second polymer-based material ii) with the first polymer-based material i) prior to foaming.

It is preferred that the composite material is resistant to permanent set under all types of loading; e.g. compression, tension or shear, or any combination thereof.

Preferably, the matrix of the first polymer-based material i) is a solid matrix, i.e. a matrix material which retains its own boundaries without need of a container.

The composite material may be suitable for use in a pad of the present invention without foaming, i.e. it may be unfoamed as such, or it may be produced as a precursor to a composite material which is subsequently to be foamed, i.e. that is foamed after the second polymer-based material ii) has become entrapped in a matrix of the first polymer-based material i).

Preferably, the first polymer-based material i) and second polymer-based material ii) are in intimate admixture; for example, as attainable by blending i) and ii) together. By blending is meant herein the mixing together of polymer-based material i) and polymer-based material ii) in the semi-molten or molten state to form a composite material wherein the first polymer-based material i) and the second polymer-based material ii) are in intimate admixture. Where the composite material is unfoamed, the first polymer-based material i) and the second polymer-based material ii) are mixed prior to formation of the matrix. Similarly, where the composite material is foamed, the first polymer-based material i) and the second polymer-based material ii) are mixed prior to foaming. Thus, in each case, the second-polymer based material ii) is distributed within the body of a matrix/foam formed from the first polymer-based material ii) in the finished composite material.

The preferred composite materials for use in pads of the invention are self-supporting and offer a degree of impact protection which can exceed that of current rigid systems. Moreover, in a preferred embodiment wherein the composite material is both flexible and resilient under all types of loading, it has the ability to conform to the geometry of whatever it is desired to protect by maintaining intimate contact through relatively large changes in geometry. This is important for the design of protective components because induced damage is a function of maximum force resulting from the impact divided by the area over which this force is distributed. The composite material enables both a reduction in the force and an increase in the area on which the force acts or is reacted, thereby significantly reducing the resulting pressure or stress transmitted for a given impact event. It also offers the ability to exhibit some conformity to the impactor and thus produce additional force absorption as well as favourable geometry in terms of abrasion resistance.

The first polymer-based material i) may be one wherein the polymer comprising the first polymer-based material i) comprises ethylene-vinyl acetate (EVA), or an olefin polymer, for example polypropylene, or an ethylene polymer, such as high pressure polyethylene (LDPE), LLDPE or HDPE.

Preferably, the polymer comprising the first polymer-based material i) comprises an elastomer. While natural elastomers, e.g. latex rubbers, may be used, synthetic elastomers (such as neoprene), more preferably synthetic thermoplastic elastomers, such as thermoplastic polyesters, are preferred. Preferred classes of such elastomers include elastomeric polyurethanes and elastomeric EVAs (ethylene/vinyl acetate copolymers), and others, such as silicone rubbers, polyurethanes and EP rubbers, e.g. EPDM rubbers, may be suitable.

Any polymer-based material, different from i), which exhibits dilatancy and can be incorporated into the chosen elastic constituent(s) of first polymer-based material i) may be used as second polymer-based material ii). By a polymer-based material which exhibits dilatancy is meant a material in which the dilatancy is provided by one or more polymers alone or by a combination of one or more polymers together with one or more other components, e.g. finally divided particulate material, viscous fluid, plasticiser, extender or mixtures thereof, and wherein the polymer is the principle component. In one preferred embodiment, the polymer comprising the second polymer-based material ii) is selected from silicone polymers exhibiting dilatant properties. The silicone-based polymer is preferably selected from borated siloxane polymers. For example, the dilatant may be selected from filled or unfilled polyborodimethylsiloxanes (PBDMSs) or any number of polymers where PBDMS is a constituent. The dilatancy may be enhanced by the inclusion of other components, such as particulate fillers.

The dilatant may be combined with other components in addition to the components providing the dilatancy, e.g. fillers, plasticisers, colourants, lubricants and thinners. The fillers may be particulate (including microspheres or microballoons), or fibrous, or a mixture of particulate and fibrous. One class of particular preferred dilatants based on PBDMS comprises the borated silicone-based materials that are marketed under the generic name of silicone bouncing putties and are produced by various manufacturers. These include those by Dow Corning under product catalogue number and by Wacker GmbH under product numbers M48 and M29. Other companies such as Rhodia, GE Plastics, and ICI have also produced these materials, and other polymer-based dilatant materials having similar dilatancy characteristics, e.g. a similar modulus at low rates of strain and a similar plot of modulus with respect to the applied strain rate.

The composite material for use in forming the body of a pad according to the invention may be comminuted for ease of handling or for moulding purposes.

The elastic, energy absorbent material suitable for forming a body of a pad according to the invention may have any suitable density, such as generally from about 1,200 kg/m³ in the as blended condition and any intermediate density down to about kg/m³ in the foamed form, and preferably from about 1,100 kg/m³ to about 130 kg/m³.

Before foaming the elastic, energy absorbent composite material suitable for foaming a body of a pad according to the invention may comprises a weight ratio of first polymer-based material i) to second polymer-based material ii) of from 16 to 0.062, preferably from 8 to 0.125, more preferably from 4 to 0.25.

In a foamed elastic, energy absorbent composite material suitable for foaming the body of a pad according to the invention, the dilatant will, in general, form from 2 to 70%, preferably 10 to 50%, more preferably 15 to 40% by volume of the composite, measured as a percentage of the solid components of the foam. Furthermore, the amount of gas or vapour will generally be such that the gas or vapour content of the composite is from 20 to 90%, preferably from 30 to 80%, more preferably from 40 to 70% by volume (these figures excluding fillers or other additional components).

In a particular embodiment, the composite material forming the body of a pad according to the invention has been foamed; suitably, the so-produced foam is a closed cell foam. Suitably, at least part of the second polymer-based material ii) is included within cell walls of the foam. In this embodiment, the cells of the foam may include, as pneumatagen, a gas, vapour, supercritical liquid, or a precursor thereof; for example, nitrogen or carbon dioxide.

Foamed composite materials for use in forming the body of a pad according to one embodiment of the invention may be prepared by combining the polymer intended to comprise the first polymer-based material i); the polymeric dilatant intended to comprise the second polymer-based material ii); and a gas, vapour, supercritical liquid, or precursor thereof, such that the dilatant and the gas or vapour are distributed, generally substantially uniformly, throughout the matrix to produce a resiliently compressible material which exhibits a resistive load under deformation which increases with the rate of deformation. One suitable method comprises incorporating a polymer-based dilatant into a foamed synthetic elastomer, preferably during the formation of the foam.

An alternative method may comprise incorporating an unfoamed mixture of the first polymer-based material i) and the second polymer-based material ii) in the barrel of an injection moulding machine including means for supplying a pneumatagen thereto; bringing the mixture to an elevated temperature and an elevated pressure such that it is in molten form; supplying a pneumatagen to the barrel; and reducing the pressure of the heated composite material, thereby causing foaming of the composite material. The pressure may be reduced in this process by injecting the composite material into a mould or extruding the composite material, suitably at ambient pressure. Such a process may be operated on a continuous basis. Preferably, the elevated temperature is from 150° C. to 240° C., more preferably from 170° C. to 210° C. Preferably the elevated pressure at which the pneumatagen is injected is from 1600 psi to 2000 psi, more preferably from 1700 psi to 1900 psi.

A body comprising an elastic, energy absorbent composite material for use in a pad according to the invention may also be formed in a mould. For example, a precursor mixture suitable for forming the body may be incorporated in a first mould section, which may then be closed, for example by disposing a second mould section over the precursor mixture, and the precursor mixture may be cured and/or foamed to form the body. By a precursor mixture suitable for forming the body is meant any mixture of components, preferably a molten or semi-molten mixture, that may be cured or foamed, for example a molten or semi-molten mixture of the first polymer-based material i) and second polymer-based material ii), and optionally an activating/curing component. Curing of the precursor mixture may be caused by application of suitable pressures or temperatures, and/or by the use of one or more activating components. Foaming may be caused by introduction of a pneumatagen, for example a very high pressure gas such as nitrogen, or the use of microspheres comprising a plastic shell which hermetically encapsulate a gas or vapour; and causing the gas or vapour to expand to foam the precursor mixture. The temperatures used in such processes may preferably range from 150° C. to 240° C., more preferably from 170° C. to 200° C. or 190° C. to 210° C. The elevated pressures may preferably range from 5000 psi to 12000 psi, for example from 6000 psi to 7000 psi or from 9000 psi to 11000 psi.

Particularly suitable elastic, energy absorbent materials for forming the body of a pad according to the invention are disclosed in WO 03/055339 and WO 2005/000966.

The layer of heat sensitive adhesive at least partially covering the first surface of the body of a pad according to the invention may be bonded to the entire first surface, but is at least bonded to the periphery of the first surface. In this way, once the heat sensitive adhesive is itself bonded to a textile, the entire periphery of the body will be bonded to the textile so that no loose edges are present.

Any suitable heat sensitive adhesive may be used in the invention. Suitably the heat sensitive adhesive has a melting temperature that is higher than temperatures likely to be encountered during day-to-day handling of textiles to which pads of the invention are attached, e.g. during laundering, but not so high that it is impractical to attach the pad to a textile by heat. Suitable melting temperatures are from 40° C. to 300° C., preferably from 90° C. to 250° C.

Suitably, the heat sensitive adhesive also has a softening temperature that is higher than temperatures likely to be encountered during day-to-day handling of textiles to which pads on the invention are attached, e.g. during laundering, but not so high that it is impractical to attach the pad to a textile by heat. Suitably the softening temperature is 10° C., preferably 20° C., higher than the washing temperature. Suitable softening temperatures are 40° C. or greater, preferably 50° C. or greater, 60° C. or greater, 70° C. or greater, 80° C. or greater, 90° C. or greater or 100° C. or greater.

The softening temperature, sometimes referred to as softening point, of the heat sensitive adhesive is the temperature at which the material softens beyond a defined softness. It may be determined, for example, by the Vicat method, for example by using ASTM-D1525 or ISO-306.

The washing temperature as used herein means the temperature at which textile articles to which pads of the invention are attached are to be washed, for example as indicated by instructions attached to, or provided with, the textile articles.

Preferred heat sensitive adhesives for use in the invention comprise polyamides, polyolefins, polyurethanes and mixtures thereof; particularly polyether based polyurethanes, polyester based polyurethanes and mixtures thereof.

The layer of heat sensitive adhesive may comprise multiple layers, for example Bemis OT100.

The layer of heat sensitive adhesive at least partially covering the first surface of the body of a pad according to the invention may be of any suitable thickness, for example from 0.01 mm to 0.25 mm, more particularly from 0.025 mm to 0.15 mm.

Heat sensitive adhesives may be applied to a preformed body of elastic, energy absorbent material in liquid form, and dried so as to form a continuous layer covering the first surface of the body. Alternatively, a layer of heat sensitive adhesive may be bonded to a preformed body by use of additional adhesives, such as acrylate adhesives, e.g. a cyanoacrylate adhesive. Preferably, however, the layer of heat sensitive adhesive is bonded to a body during the formation of the body.

The layer of heat sensitive adhesive covers at least a sufficient portion of the body so that the body may be attached to a fabric. Preferably, the layer of heat-sensitive adhesive covers the entire first surface of the body. By covering the first surface of the body it is meant that the layer of heat sensitive adhesive covers all parts of the first surface of the body; however, the layer of heat sensitive adhesive may optionally be larger that the body, to improve bonding to a textile. Direct contact between the heat sensitive adhesive and the first surface of the body is not necessary, other than in the areas where the heat sensitive adhesive is bonded to the first surface, i.e. at least at the periphery of the first surface. Thus, in a further embodiment of the invention, a pad according to the invention may comprise a flexible material located between the body and the layer of heat sensitive adhesive. In this embodiment, the flexible material will have a surface area smaller than the surface area of the first surface of the body, so that it will not interfere with the bonding of a layer of heat sensitive adhesive to the periphery of the body. The flexible material may be bonded to the first surface of the body, or may be unattached thereto. Similarly, the flexible material may be bonded to the layer of heat sensitive adhesive, or may be unattached thereto.

Suitably the flexible material is compressible.

Suitable flexible materials include open cell foams and spacer fabrics.

The flexible material located between the body and the layer of heat sensitive adhesive of a pad according to the invention may be any suitable thickness, for example from 0.1 to 10 mm, particularly from 0.5 to 6 mm, more particularly from 1 to 3 mm.

The inclusion of a flexible material between the body and the layer of heat sensitive adhesive may provide additional impact protection and/or flexibility in pads of the invention.

Alternatively or additionally, a pad according to the invention may comprise a flexible material located on the outer surface of the layer of heat sensitive adhesive, i.e. on the surface of the layer of heat sensitive adhesive not facing the body of the pad. The flexible material must be smaller than the layer of heat sensitive adhesive and must be positioned so as not to interfere with the ability of the heat sensitive adhesive to bond to a textile. The flexible material may be any of the materials specified herein.

In a preferred embodiment, pads according to the invention comprise a polymer layer covering the second surface of the body.

Suitably, the polymer layer covering the second surface of the body is bonded to the layer of heat sensitive adhesive covering the first surface of the body, so that the body is entirely contained within an envelope formed by the layer of heat sensitive adhesive covering the first surface of the body and the polymer layer covering the second surface of the body.

The polymer layer covering the second surface of the body may be bonded to all, or part, of the second surface of the body, or may not be bonded to any part of the second surface of the body.

The polymer layer covering the second surface of the body may comprise the same material as the layer of heat sensitive adhesive covering the first surface of the body, or any other suitable material. Similarly, the polymer layer covering the second surface of the body may be of the same thickness as the layer of heat sensitive adhesive covering the first surface of the body, or may be of a different thickness, for example it may be thicker. Suitably the polymer layer covering the second surface of the body may be from 0.01 to 0.25 mm thick, more particularly from 0.025 to 0.15 mm thick.

Suitably, the polymer layer covering the second surface of the body has both a melting temperature and a softening temperature higher than temperatures likely to be encountered during day-to-day handling of textiles to which pads of the invention are attached, e.g. during laundering.

Suitable melting temperatures for the polymer layer coving the second surface of the body are from 40 to 350° C., preferably from 90° C. to 300° C.

Suitably the softening temperature of the polymer layer covering the second surface of the body is 10° C., preferably 20° C., higher than the washing temperature. Suitable softening temperatures are 40° C. or greater, preferably 50° C. or greater, 60° C. or greater, 70° C. or greater, 80° C. or greater, 90° C. or greater or 100° C. or greater.

Suitably, the polymer layer covering the second surface of the body comprises one or more materials selected from plastics, elastomeric materials, polyolefins, polyamides, polystyrenes, ethylene-vinyl acetates, nylons, polyesters, polyethylenes, polytetrafluroethylene, silicones, vinyls, polyurethanes (including both thermoset and thermoplastic polyurethanes), polyvinyl chlorides, latex rubbers, synthetic rubbers, such as EPDM, thermoplastic elastomers, or mixtures thereof.

Preferably the polymer layer covering the second surface of the body comprises a material selected from polyamides, polyolefins, elastomeric materials, polyurethanes, for example a polyether based polyurethane or a polyester based polyurethane, silicones or mixtures thereof.

Particularly preferred materials forming the polymer layer covering the second surface of the body include polyether based polyurethanes, polyester based polyurethanes and mixtures thereof.

The polymer layer covering the second surface of the body may be a multilayer material, such as Bemis OT100.

The polymer layer covering the second surface of the body may include openings therein, and this arrangement is particularly suitable if the body comprising an elastic, energy absorbent material is water-resistant/washable. Openings in the polymer layer covering the second surface of the body may be preformed before the polymer layer is attached to the pad, or may be formed in the polymer layer after attachment to the pad, for example by punching. The inclusion of openings in the polymer layer covering the second surface of the body is particularly useful in pads according to the invention that also comprise a flexible material located between the body and the layer of heat sensitive adhesive, as the openings allow air to pass in and out of the pad in response to compression and expansion of the flexible material, improving the impact resistance of the pad.

The polymer layer covering the second surface of the body may be attached to a preformed body, for example using an adhesive, or may be attached during the formation of the body.

The incorporation of a polymer layer covering the second surface of the body provides a range of advantages in pads according to the invention. These advantages include improved impact protection, water and/or UV resistance and improved physical properties, including resistance to tearing. The polymer layer covering the second surface of the body may also improve the feel of the pad, particularly if the body of the pad is tacky to the touch.

Furthermore, selection of a suitable material for use as the polymer layer covering the second surface of the body allows the use of less dense elastic, energy absorbent materials, and/or smaller amounts of such materials, to obtain impact protection comparable to pads in which a polymer layer covering the second surface is not included. Thus, pads according to this embodiment of the invention may be lighter and/or thinner than conventional pads.

In pads according to the invention, the body may generally be substantially uniform in thickness, the thickness preferably being from 1 mm to 25 mm, more preferably from 2 mm to 20 mm.

However, in pads according to a preferred embodiment of the invention, the body includes two or more regions having different thicknesses.

In a pad according to the invention having a body including two or more regions having different thicknesses, the regions of higher thickness will generally be responsible for impact protection, and the regions of lower thickness will provide areas of increased flexibility; and the regions will therefore be distributed appropriately. Thus the regions of relatively higher thickness and the regions of relatively lower thickness may all have the same width and/or shape, or they may vary in width and shape, i.e. if a single flexible region is required, two relatively wide regions of relatively higher thickness may be separated by a single relatively narrow region of relatively lower thickness forming a folder line; alternatively, if the pad is intended to be generally flexible, a number of relative small regions of relatively higher thickness will be surrounded by narrow regions of relatively lower thickness, so that each region of relatively higher thickness may be flexed easily with respect to each other region of relatively higher thickness.

In pads of the invention having two or more regions of relatively higher thickness, each region of relatively higher thickness may have the same thickness, or different regions of relatively higher thickness may have different thicknesses. Similarly, each region of relatively higher thickness may have the same width, or different regions of relatively higher thickness may have different widths. Furthermore, in pads of the invention having two or more regions of relatively lower thickness, each region of relatively lower thickness may have the same thickness, or different regions of relatively lower thickness may have different thicknesses. Similarly, each region of relatively lower thickness may have the same width, or different regions of relatively lower thickness may have different widths.

In a pad according to the invention having a body including two or more regions having different thicknesses, the regions of lower relative thickness may optionally have zero thickness, i.e. the pad may comprise separate discrete portions of elastic, energy absorbent material with gaps between, or regions of zero thickness may be formed in a continuous body, for example, by punching. Preferably the regions of higher relative thickness have a thickness of from 4 mm to 25 mm, more preferably from 6 mm to 15 mm, and the regions of lower relative thickness have a thickness of from 0 mm to 6 mm, more preferably from 0 mm to 3 mm, for example from 2 mm to 3 mm.

In pads according to the preferred aspect of the invention wherein the body includes two or more regions having different thicknesses, it is particularly advantageous for the pad to also include a polymer layer covering the second surface of the body, as discussed above. In particular, the resistance to tearing provided by a polymer layer covering the second surface of the body allows very thin sections to be incorporated in the body to improve flexibility of the body.

The inclusion of a polymer layer covering the second surface of the body in pads according to the invention also allows one or more materials to be located between the body and the polymer layer covering the second surface of the body. Such materials can provide numerous advantages, including improved impact resistance, light and/or UV protection and/or improvements in the appearance of the pad. The material located between the body and the polymer layer covering the second surface of the body may be selected from flexible materials, compressible materials, plastics, textiles and metals, for example plastic or metal caps providing improved impact resistance.

Where one or more materials are located between the body and the polymer layer covering the second surface of the body, the materials may be wholly, or partly, attached to the body, or may be unattached thereto. Similarly, the one or more materials located between the body and the polymer layer covering the second surface of the body may be partly, or wholly, attached to the polymer layer, or may be completely unattached thereto.

In pads according to the invention comprising a polymer layer covering the second surface of the body one or more materials may be attached to the outer surface of the polymer layer covering the second surface of the body. Alternatively, in pads according to the invention not comprising a polymer layer covering the second surface of the body, one or more materials may be attached directly to the second surface of the body. The attachment of such material can provide numerous benefits, including improved impact resistance, improved resistance to damage, e.g. abrasion, and improved UV resistance. The material attached to the outer surface of the polymer layer covering the second surface of the body, or attached directly to the second surface of the body, may also improve the look and/or feel of pads according to this embodiment of the invention.

Suitable materials for attachment to the outer surface of the polymer layer covering the second surface of the body, or attached directly to the second surface of the body, may be selected from compressible materials, plastics, metals, polyamides and flexible materials, including fabrics and acrylonitrile butadiene styrene. Particularly suitably, plastic or metal caps may be attached to the outer surface of the polymer layer to provide improved impact resistance, and/or a layer of fabric may be attached to the outer surface of the polymer layer to improve the look or feel of the pad.

Where the materials attached to the outer surface of the polymer layer covering the second surface of the body, or attached directly to the second surface of the body, are materials having softening temperatures, the softening temperatures are suitably higher than temperatures likely to be encountered during day-to-day handling of textiles to which pads of the invention are attached, e.g. during laundering. Suitably the softening temperatures of the materials for attachment to the outer surface of the polymer layer covering the second surface of the body, or attached directly to the second surface of the body, are 10° C., preferably 20° C., higher than the washing temperature. Suitable softening temperatures are 40° C. or greater, preferably 50° C. or greater, 60° C. or greater, 70° C. or greater, 80° C. or greater, 90° C. or greater or 100° C. or greater.

In a particularly preferred embodiment of the present invention, the softening temperatures of the heat sensitive adhesive and all of the materials forming all other surfaces of the pad are at least 10° C. higher, more preferably 20° C. higher, than the washing temperature, ie the temperatures at which the textiles to which the pads are attached are likely to be laundered. Suitable softening temperatures are 40° C. or greater, preferably 50° C. or greater; or, where it is expected that textiles to which pads according to the invention are attached will be laundered at higher temperatures, or exposed to higher temperatures for any other reason, higher minimum softening temperatures may be used, for example 60° C. or greater, 70° C. or greater, 90° C. or greater, 100° C. or greater or 120° C. or greater.

By ensuring that the softening temperatures of the heat sensitive adhesive and of the materials forming all of the surfaces of the pad are at least 10 degrees higher than the washing temperature and/or temperatures likely to be encountered during day-to-day handling of the textiles, the lifetime of the pads may be extended by reducing the likelihood of the surface layers becoming delaminated, for example, during laundering.

In certain embodiments of the present invention, it is useful for the melting temperature of the surface of the pad opposite the surface to which the heat sensitive adhesive is bonded, i.e. the outer surface of the pad when the pad is attached to a textile, to have a melting temperature of substantially the same value as the melting temperature of the heat sensitive adhesive. This is particularly useful when it is intended that the pad according to the present invention will be attached to a first textile and also that the pad should be covered by a second textile layer, as, in this case, the pad may be attached to the first textile layer and the second textile layer using a single heating/pressing process. In this embodiment the surface of the pad opposite the surface to which the heat sensitive adhesive is bonded may suitably be formed from the same material as the heat sensitive adhesive.

In an alternative, preferred embodiment, the melting temperature of the materials forming the surface of the pad opposite the surface to which the heat sensitive adhesive is bonded is higher than the melting temperature of the heat sensitive adhesive so that the heating required in order to cause the heat sensitive adhesive to adhere to a fabric will not melt, or otherwise adversely affect, the material forming the outer layer of the pad once it is attached to the textile. Suitably, the melting temperatures of the materials forming the surface of the pad opposite the surface to which the heat sensitive adhesive is bonded are at least 20° C. higher, preferably at least 30° C. higher, than the melting temperature of the heat sensitive adhesive.

More particularly, where the pad according to the present invention does not comprise any material attached to the second surface of the body, the melting temperature of the second surface of the body is suitably at least 20° C. higher, preferably at least 30° C. or higher, than the melting temperature of the heat sensitive adhesive. Similarly, where the pad according to the present invention comprises a polymer layer covering the second surface of the body, the melting temperature of the polymer layer covering the second surface of the body is suitably at least 20° C. higher, preferably at least 30° C. higher, than the melting temperature of the heat sensitive adhesive. Further, where one or more materials are attached to the second surface of the body, or where one or more materials are attached to the outer surface of the polymer layer covering the second surface of the body, suitably the melting temperature of the one or more materials is at least 20° C. higher, preferably at least 30° C. higher, than the melting temperature of the heat sensitive adhesive.

By selecting a melting temperature of the materials forming the surface of the pad opposite the surface to which the heat sensitive adhesive is bonded of at least 20° C. higher, preferably at least 30° C. higher, than the melting temperature of the heat sensitive adhesive, damage to the pads during attachment to textiles may be substantially reduced.

The present invention also provides a process for the preparation of a pad according to the hereinbefore described invention which comprises bonding a layer of heat sensitive adhesive to at least a periphery of the first surface of the body.

The process of the present invention may be carried out by bonding a layer of heat sensitive adhesive to at least the periphery of the first surface of a preformed body, and the bonding may be carried out by use of adhesives, such as acrylate based adhesives.

Alternatively, and preferably, the process of the invention comprises causing the layer of heat sensitive adhesive to become bonded to at least the periphery of the first surface of the body during the formation of the body.

Causing the layer of heat sensitive adhesive to become bonded to at least the periphery of the first surface of the body during the formation of the body avoids the use of additional adhesive materials, and will generally produce a stronger and more lasting bond, so that the layer of heat sensitive adhesive may not be removed from the body under any conditions likely to be encountered during normal use or processing of the pad.

As discussed herein, the body comprising an elastic, energy absorbent material of pads according to the invention can be formed from precursor mixtures, and the process of the invention may be carried out by bringing the layer of heat sensitive adhesive into contact with the precursor mixture during the curing and/or foaming process leading to the formation of the body. For example, if the body is formed by extrusion from the barrel of an injection moulding machine, the layer of heat sensitive adhesive may be brought into contact with the body as it is extruded from the injection moulding.

In a particular embodiment of this aspect of the invention, the process for the preparation of a pad according to the invention comprises disposing a precursor mixture suitable for forming the body in a first mould section, disposing a layer of heat sensitive adhesive over the precursor mixture, disposing a second mould section over the layer of heat sensitive adhesive, and causing the precursor mixture to cure and/or foaming the precursor mixture to form the body.

In a further aspect, the process for the preparation of a pad according to the invention, wherein the pad comprises a flexible material located between the body and the layer of heat sensitive adhesive, comprises disposing a precursor mixture suitable for forming the body in a first mould section, disposing a flexible material over a portion of the precursor mixture so that at least the periphery of the precursor mixture is not covered by the flexible material, disposing a layer of heat sensitive adhesive over the precursor mixture and the flexible material, disposing a second mould section over the layer of heat sensitive material, and causing the precursor mixture to cure and/or foaming the precursor mixture to form the body.

In a further aspect of the process of the present invention, when the pad according to the present invention comprises a polymer layer covering the second surface of the body, the process for preparation of the pad comprises disposing the polymer layer in a first mould section, disposing a precursor mixture suitable for forming the body over the polymer layer, disposing a layer of heat sensitive adhesive over the precursor mixture, disposing a second mould section over the layer of heat sensitive adhesive, and causing the precursor mixture to cure and/or foaming the precursor mixture to form the body.

Various aspects of the process of the invention may be combined; for example, pads according to the present invention comprising both a flexible material located between the body and the layer of heat sensitive adhesive, and a polymer layer covering the second surface of the body, may be produced by combining various features of the above aspects of the process of the invention.

Preferably, in the process of the present invention the elastic energy absorbent material is a composite material as hereinbefore defined, the heat sensitive adhesive is as hereinbefore defined, the flexible material, where present, is as hereinbefore defined, and the polymer layer, where present, is as hereinbefore defined.

In a preferred embodiment of the process of the present invention, the precursor mixture suitable for forming the body is selected so that the mould becomes fully filled during the foaming/curing process, and particularly so that the formation of air pockets in the mould is eliminated or reduced. This may be achieved by use of a precursor mixture having a suitable viscosity value and suitable Cream Time, so that the foaming action will create an even expansion in an outwards and upwards direction. This is particularly important where the body of the pad has two or more regions having different thickness, so that the mould in which the body is formed must also comprise regions of different depths, as this can lead to uneven filling and/or the formation of air pockets during the foaming process if a suitable precursor mixture is not used. Suitably the viscosity of the precursor mixture when measured at 20° C. is from 1400 to 2800 mPa·s, preferably from to 2400 mPa·s, more preferably from 2000 to 2300 mPa·s. Suitably, the Cream Time of the precursor mixture is from 3 to 8 seconds, preferably from 5 to 7 seconds.

The Cream Time is the interval of time between activation of the precursor mixture and the first definite appearance of foam expansion.

A suitable viscosity for the precursor mixture may be achieved by using polymer materials having suitable viscosities before foaming.

The Cream Time may be adjusted, if necessary, by adding a suitable amount of an additive to adjust the Cream Time. Any suitable additive may be used to adjust the Cream Time, but preferably it should not have a significant adverse effect on the properties of the polymer body. For example, where the precursor mixture comprises a polyurethane system, such as the polyurethane foam referenced as J-Foam 7087, marketed by Jacobson Chemicals Limited, the Cream Time may be adjusted by the addition of from 0.2 to 0.4 wt % of a tertiary amine catalyst, for example a 70% bis (2-dimethylaminoethyl) ether diluted with 30% dipropylene glycol, such as Dabco BL-11.

The invention further provides a pad for attachment to a textile prepared by a hereinbefore described process of this invention.

This invention further provides textile articles comprising one or more pads according to the invention attached to a textile.

By a textile is meant a material that is produced from fibres, filaments, yarns or mixtures thereof. Preferred textiles for use in the invention are generally flexible, woven or non-woven, and may be formed from entirely natural materials, entirely artificial materials, or mixtures of natural and artificial materials, for example, a fabric.

Particularly suitable textiles for use in the invention comprise woven or non-woven fabrics comprising natural and/or artificial material, including spandex or elastane (lycra), cordura, aramids, cotton and canvas. Particularly preferred textiles are suitable for forming garments or other articles for attachment to the human or animal body, or packaging materials and/or articles for protecting impact sensitive components during transport and/or use, including electronics carrying cases, hand luggage, strapping systems for backpacks and other articles, or shoulder straps.

Preferred textile articles according to the invention include protective garments and protective pads. By a protective garment is meant any article that may be worn on the human or animal body and which provides protection thereto due to the attachment to the textile article of one or more pads according to the invention. Examples of protective garments include hats, shirts, jackets, trousers, socks, athletic supports, underwear, bras, gloves, coats and all-in-one bodysuits (for example, wet suits). Pads according to the invention may be attached to the inside or outside of the garments, and the size and/or number of pads attached to the garments may vary depending upon the size of the garment and the amount of protection and/or size of the areas of protection required.

By a protective pad is meant a pad according to the present invention attached to a textile so that it may be comfortably positioned on the human or animal body. For example, the protective pad may incorporate straps or a sleeve of varying sizes, so that the protective pad may be attached to one or more parts of the body. Suitably, protective pads may include pads adapted to be attached to the chest, back, upper or lower arms, elbows, stomach, hips, groin, upper and lower legs or feet of an individual, for example knee pads and elbow pads.

Pads according to the present invention are suitable for attachment to a textile by heating, and the present invention therefore also provides a process for the preparation of a textile article according to the invention, comprising placing the layer of heat sensitive adhesive covering the first surface of the body of a pad according to the present invention in contact with a textile and applying sufficient heat to melt the heat sensitive adhesive and cause the pad to become attached to the textile.

In an alternative embodiment, the present invention provides a process for the preparation of a textile article according to the invention, comprising placing a first surface of a layer of heat sensitive adhesive in contact with a textile and placing in contact with the opposing surface of the layer of heat sensitive adhesive a pad comprising a body comprising an elastic, energy absorbent material, which exhibits a resistive load under deformation which increases with the rate of deformation, the body having a first surface and an opposing second surface, and applying sufficient heat to melt the heat sensitive adhesive and cause the pad to become attached to the textile. In this embodiment, the pad is preferably a pad as herein defined but excluding the layer of heat sensitive adhesive at least partially covering the first surface of the body, and/or the layer of heat sensitive adhesive is as herein defined.

When required, pads according to the invention may also be relatively easily removed from textiles to which they have been attached, by application of sufficient heat to re-melt the heat sensitive adhesive bonding the body of the pad to the textile.

In a preferred aspect of the processes for the preparation of textile articles according to the invention, the processes comprise bringing the layer of heat sensitive adhesive into contact with a first surface of the textile and bringing a heated surface into contact with the opposing surface of the textile in the region where the heat sensitive adhesive contacts the textile. The heated surface may be at any temperature suitable to cause the heat sensitive adhesive to melt and bond to the textile, but not to cause damage to the textile.

Preferably the textile is as defined herein and/or the textile article is as defined herein.

In the process for the preparation of a textile article according to the invention, suitably at least some pressure is applied during the heating step to improve contact between the layer of heat sensitive adhesive and the textile, and to thereby prevent movement of the pad and promote bonding between the pad and the textile. Suitable pressures range from 2 to 6 bar.

The processes for the preparation of textile articles according to the above preferred aspects of the invention may be carried out on an industrial scale, for example using a heat press or similar equipment to simultaneously attach one or more pads according to the invention to one or more textiles. Alternatively, this aspect of the invention may be carried out by an individual, for example by ironing.

The present invention further provides textile articles obtainable by the hereinbefore described processes of the invention.

The present invention further provides kits for producing textile articles according to the invention, comprising one or more pads according to the invention and a textile.

The present invention further provides kits for producing textile articles according to the invention, comprising a of heat sensitive adhesive and a pad comprising a body comprising an elastic, energy absorbent material, which exhibits a resistive load under deformation which increases with the rate of deformation, the body having a first surface and an opposing second surface. In this embodiment, the pad is preferably a pad as herein defined but excluding the layer of heat sensitive adhesive at least partially covering the first surface of the body, and/or the sheet of heat sensitive adhesive is as herein defined.

The present invention further provides the use of a pad according to the invention for the preparation of a textile article by attaching the pad to a textile by heating.

The present invention will now be described by way of example and with reference to the accompanying Figures, in which:

FIG. 1 of the accompanying drawings is a schematic diagram depicting a pad according to a first embodiment of the present invention;

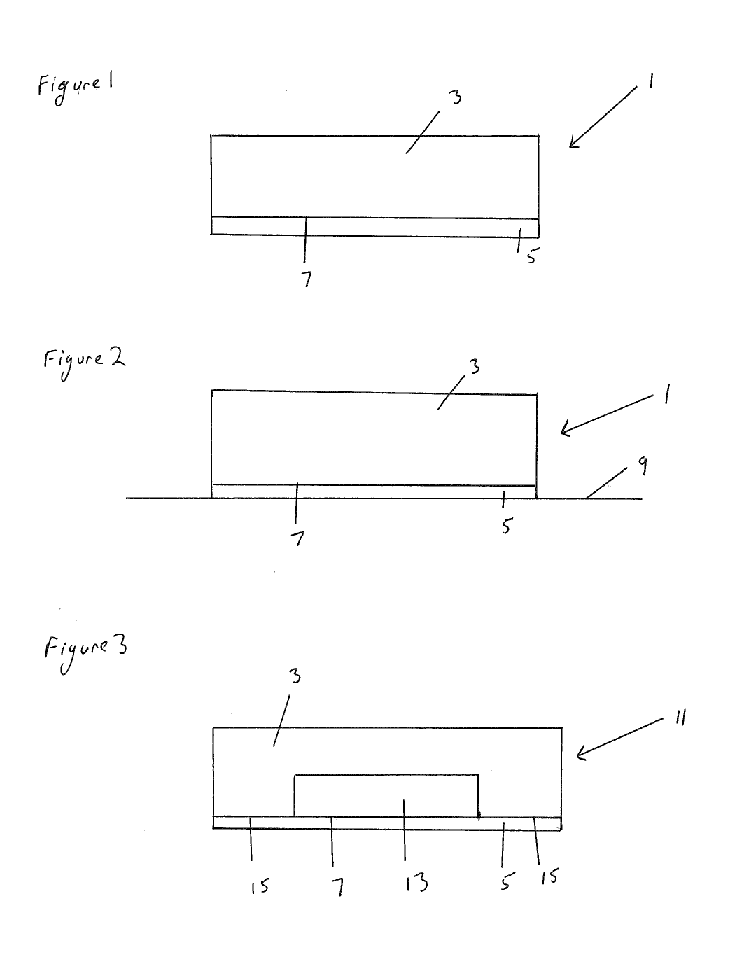

FIG. 2 of the accompanying drawings is a schematic diagram of a pad according to a first embodiment of the present invention attached to a textile;

FIG. 3 of the accompanying drawings is a schematic diagram of a pad according to a second embodiment of the present invention;

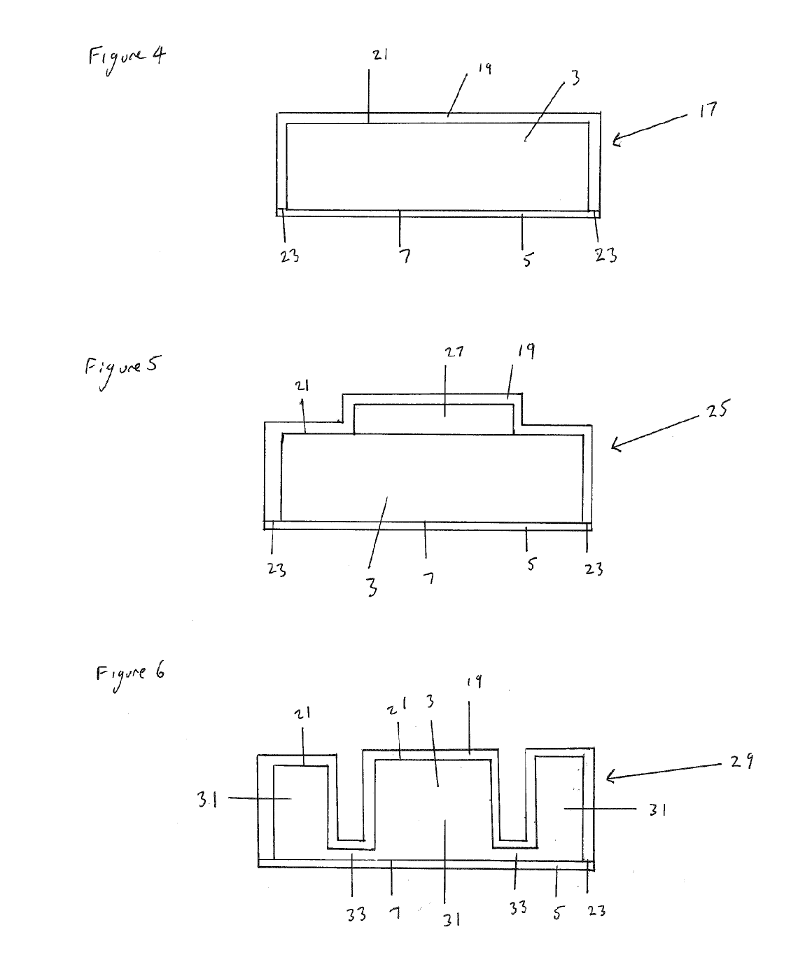

FIG. 4 of the accompanying drawings is a schematic diagram of a pad according to a third embodiment of the present invention;

FIG. 5 of the accompanying drawings is a schematic diagram of a pad according to a fourth embodiment of the present invention; and

FIG. 6 of the accompanying drawings is a schematic diagram of a pad according to a fifth embodiment of the present invention.

The following Examples illustrate the invention.

### EXAMPLE 1

A pad according to the first aspect of the invention is illustrated in FIG. 1. The pad 1 was made by disposing a precursor mixture comprising a PU system, such as modelling foam referenced as J-Foam 7087, marketed by Jacobson Chemicals Ltd., premixed with a dilatant into a first mould section.

A layer of heat sensitive adhesive 5 comprising a polyurethane (Bemis OT100) is disposed over the top of the precursor mixture in the mould section, and a second mould section is disposed over the layer of heat sensitive adhesive to close the mould.

The precursor mixture inside the mould is caused to foam and cure, and once this is complete, the mould is opened and the pad 1 is removed from the mould. When the pad 1 is removed from the mould, the layer of heat sensitive adhesive 5 may extend beyond the edges of the body 3 (for example in the form of a “skirt”); however, this additional material may be removed, for example by cutting, so that the layer of heat sensitive adhesive 5 does not extend beyond the edges of the body 3.

As shown in FIG. 1, the pad 1 comprises a body 3, which is elastic, energy absorbent and exhibits a resistive load under deformation which increases with the rate of deformation. A layer of heat sensitive adhesive 5 covers the first surface 7 of the body and is bonded thereto.

As shown in FIG. 2, when the layer of heat sensitive adhesive of pad 1 is placed in contact with a fabric 9 (for example a cotton fabric suitable for forming a sports shirt) and heat is applied, for example by use of a domestic iron, the layer of heat sensitive adhesive 5 melts and bonds the body 3 of the pad 1 to the fabric 9.

### EXAMPLE 2

FIG. 3 illustrates an example of a pad 11 according to the present invention comprising a flexible material 13 located between the body 3 and the layer of heat sensitive adhesive 5.

The pad 11 is formed from the same materials and in the same manner as the pad 1 of Example 1, with the exception that after the precursor mixture has been disposed in the first mould section, a layer of flexible material 13 in the form of an open cell foam, spacer fabric, is disposed above the precursor mixture. The flexible material has a smaller diameter than the first mould section, and is placed in the centre of the precursor mixture so that the edges of the precursor mixture are not covered by the flexible material 13. A layer of heat sensitive adhesive 5 as used in Example 1 is then disposed over the flexible material and polymer precursor, and the mould is closed by disposing a second mould section over the layer of heat sensitive adhesive 5.

The precursor mixture is caused to foam and cure, as discussed in Example 1, and upon completion, the mould is opened and the pad 11 is removed therefrom.

As shown in FIG. 3, the pad 11 comprises a body 3 comprising an elastic, energy absorbent composite material which exhibits a resistive load under deformation which increases with rate of deformation, and a layer of heat sensitive adhesive 5 covering the first surface 7 of the body 3 and being bonded to the periphery 15 of the first surface 7. A flexible material 13 is located between the body 3 and the layer of heat sensitive adhesive 5.

The pad 11 may be attached to a fabric as discussed in Example 1.

### EXAMPLE 3

FIG. 4 illustrates a pad 17 in accordance with a further embodiment of the present invention, comprising a polymer layer 19 covering the second surface 21 of the body 3.

The pad 17 is formed using the same materials and procedures discussed in Example 1, with the exception that before the precursor mixture is disposed in the first mould section, a polymer layer 19 comprising a polyurethane (Bemis OT100) is disposed in the first mould section. The polymer precursor and layer of heat sensitive adhesive 5 are then disposed in the first mould section, as discussed in Example 1, and the mould is closed by disposing a second mould section over the layer of heat sensitive adhesive 5.

The precursor mixture is caused to foam and cure, as discussed in Example 1, and on completion the mould is opened by removing the second mould portion, and the pad 17 is removed from the first mould portion.

As shown in FIG. 4, the pad 17 comprises a body 3 comprising elastic, energy absorbent composite material, which exhibits a resistive load under deformation which increases with the rate of deformation, having a first surface 7 and a second surface 21. A layer of heat sensitive adhesive 5 is bonded to the first surface 7 of the body 3, and a layer of polymer 19 covers the second surface 21 of the body 3. The layer of polymer 19 is bonded to the layer of heat sensitive adhesive 5 at the edges 23 thereof, so that the body 3 is entirely encased in an envelope formed by the heat sensitive adhesive layer 5 and the polymer layer 19.

The pad 17 may be attached to a fabric, as discussed in Example 1.

### EXAMPLE 4

FIG. 5 illustrates a pad 25 according to a further embodiment of the invention comprising a polymer layer 19 covering the second surface 21 of the body 3 and a layer of plastic 27 located between the body 3 and the layer of polymer 19.

The pad 25 is prepared using materials and conditions similar to those employed in Example 3, with the exception that, following the disposition of the polymeric layer 19 in the first mould section, a layer of polyamide plastic 27 is disposed above the polymer layer 19. The layer of plastic 27 is smaller in diameter than the first mould section, and the layer of plastic 27 is placed in the centre thereof, so that at least part of the polymer layer 19 is not covered by the layer of plastic 27.

The precursor mixture is then disposed over the polymer layer 19 and the layer of plastic 27, layer of heat sensitive adhesive 5 is disposed over the precursor mixture, and the mould is closed, as discussed in Example 3.

The precursor mixture is foamed and cured, as discussed in Example 3, and upon completion, the mould is opened by removal of the second mould section, and the pad is removed from the first mould section.

As shown in FIG. 5, the pad 25 comprises a body 3 comprising an elastic, energy absorbent composite material, which exhibits a resistive load under deformation which increases with rate of deformation, having a first surface 7 and a second surface 21. A layer of heat sensitive adhesive is bonded to the first surface 7 of the body 3, and a layer of plastic 27 is in contact with the opposing surface 21 of the body 3. A polymer layer 19 covers the upper surface 21 of the body 3 and the plastic layer 27, and is bonded to the layer of heat sensitive adhesive 5 at the edges thereof 23.

The pad 25 may be bonded to a fabric, as discussed in Example 1.

### EXAMPLE 5

FIG. 6 illustrates a pad 29 in accordance with a further embodiment of the invention, in which the body 3 of the pad 29 comprises regions of differing thickness 31, 33.

The pad 29 is prepared using materials and conditions similar to those employed in Examples 1 to 4; however the first section of the mould used to form the pad 29 differs from the mould used in those Examples, in that the inner profile of the first mould section is not uniform, i.e. the mould comprises a number of regions of differing depths.

Pad 29 is formed by disposing a layer of polymer material 19 in the first mould section and conforming the polymer layer 19 to the profile of the mould section, for example by application of a vacuum and/or suitable heating. A precursor mixture is then disposed in the first mould section, and a layer of heat sensitive adhesive 5 is disposed over the precursor mixture. The mould is then closed by the application of a second mould section over the layer of heat sensitive adhesive 5.

The precursor mixture is foamed and cured, as discussed in example 3, and upon completion, the mould is opened by removal of the second mould section, and the pad 29 is removed from the first mould section.

As shown in FIG. 6, the pad 29 comprises a body 3 of elastic, energy absorbent composite material which exhibits a resistive load under deformation which increases with the rate of deformation. The body 3 comprises regions of different thickness, including regions of relatively high thickness 31, and regions of relatively low thickness 33. The widths of the regions of relatively high thickness 31 may each be the same or may vary. Similarly, the widths of the regions of relatively low thickness 33 may each be the same or may vary. Generally the widths of the areas of relatively high thickness 31 will be larger than the widths of the regions of relatively low thickness 33, although in some embodiments this may not be the case.

The first surface 7 of the body 3 is entirely covered by a layer of heat sensitive adhesive 5, and the opposing surface 21 of the body 3 is entirely covered by the polymer layer 19, which conforms in profile to the profile of the body 3. The polymer layer 19 is bonded to the layer of heat sensitive adhesive 5 at the edges thereof 23.

The pad 29 may be attached to a textile, for example a manmade textile suitable for forming a protective garment, by heating, as discussed in Example 1. On an industrial scale a number of pads 29 may be attached to one or more fabrics using thermal processing, for example by heat pressing.

### EXAMPLE 6

Examples 1 and 2 were repeated, to prepare pads as illustrated in FIGS. 1 to 3, using materials and conditions similar those employed in Examples 1 and 2 but replacing the material used to form the heat sensitive adhesive 5 (Bemis OT100) by an alternative polyurethane, SEF Tattoo, having a softening point of 130° C.

### EXAMPLE 7

Examples 3 to 5 were repeated, to prepare pads as illustrated in FIGS. 4 to 6, using materials and conditions similar to those employed in Examples 3 to 5 but replacing the material forming the layer of heat sensitive adhesive 5 and forming the polymer layer 19 covering the second surface 21 of the body 3 (Bemis OT100) by an alternative polyurethane, SEF Tattoo, having a softening temperature of 130° C. The high softening temperatures of the heat sensitive adhesive layer 5 and the polymer layer covering the second surface 21 of the pad 3 resulted in pads that were extremely resilient to high temperature conditions, such as during repeated laundering at 90° C.

### EXAMPLE 8

Examples 3 to 5 were repeated, to produce pads as illustrated in FIGS. 4 to 6, using materials and conditions similar to those employed in Examples 3 to 5, but replacing the material forming the layer of heat sensitive adhesive 5 by Sealon 5090, having a melting temperature of 120° C. to 140° C. The material forming polymer layer 19 covering the second surface 21 of the body 3 (Bemis OT100) was also replaced by an alternative polyurethane, Sealon 3095, having a melting point of 150 to 170° C. The differences in the melting temperatures of the adhesive layer 5 and the polymer layer 19 covering the second surface 21 of the body 3 resulted in pads which were particularly suitable for attachment to fabrics by the application of heat/pressure without causing any damage to the polymer layer 19 covering the second surface 21 of the body 3.

### EXAMPLE 9

Example 5 was repeated to produce a pad, as illustrated in FIG. 6, using materials and conditions similar to those employed in Example 5, with the exception that 0.4% of a tertiary amine catalyst (Dabco BL-11) was added to the precursor mixture comprising a polyurethane system (J-Foam 7087) when the precursor mixture was dispersed in the mould. The use of the tertiary amine catalyst resulted in a reduction in the Cream Time from 15 seconds to 5 seconds, which in turn ensured that, on foaming, the precursor mixture expanded outwardly and upwards in an even manner, thereby avoiding the formation of air pockets in the mould and improving the structure of the finished pad.

1. A pad for attachment to a textile by heating, the pad comprising:
a body comprising an elastic, energy absorbent material, which exhibits a resistive load under deformation which increases with the rate of deformation,
the body having a first surface and an opposing second surface, and
a layer of heat sensitive adhesive at least partially covering the first surface of the body and being bonded to the first surface, at least at the periphery thereof,
so that the pad may be attached to a textile by heating.

2. A pad according to claim 1, wherein the elastic, energy absorbent material is a composite material which comprises i) a first polymer-based material and ii) a second polymer-based material, different from i), which exhibits dilatancy in the absence of i), wherein the second polymer-based material ii) is entrapped in a matrix of the first polymer-based material i), the composite material being unfoamed or foamed, and, when unfoamed being preparable by incorporating the second polymer-based material ii) with the first polymer-based material i) prior to formation of the matrix, or, when foamed, being preparable by incorporating the second polymer-based material ii) with the first polymer-based material i) prior to foaming.

3. A pad according to claim 2, wherein the first polymer-based material i) and the second polymer-based material ii) are in intimate admixture.

4. A pad according to claim 2 or claim 3, wherein the first polymer-based material i) comprises ethylene vinyl acetate (EVA), an olefin polymer or an ethylene polymer.

5. A pad according to claim 4, wherein the first polymer-based material i) comprises polypropylene, high pressure polyethylene (LDPE), LLDPE or HDPE.

6. A pad according to claim 2 or claim 3, wherein the first polymer-based material i) comprises an elastomer.

7. A pad according to claim 6, wherein the elastomer is a natural elastomer, such as latex rubber, or a synthetic elastomer.

8. A pad according to claim 7, wherein the synthetic elastomer is a silicone rubber, a polyurethane or an EP rubber, such as EPDM.

9. A pad according to claim 7, wherein the synthetic elastomer is a thermoplastic elastomer.

10. A pad according to claim 9, wherein the thermoplastic elastomer comprises a polyester.

11. A pad according to any of claims 2 to 10, wherein the second polymer-based material (ii) comprises a silicone polymer exhibiting dilatant properties.

12. A pad according to claim 11, wherein the silicone polymer comprises a borated siloxane polymer.

13. A pad according to claim 12, wherein the silicone polymer comprises a filled polyborodimethylsiloxane.

14. A pad according to any of claims 2 to 13, wherein the composite material has been foamed.

15. A pad according to claim 14, wherein the foam is a closed cell foam.

16. A pad according to claim 14 or claim 15, wherein at least part of the second polymer-based material ii) is included within cell walls of the foam.

17. A pad according to any of claims 14 to 16, wherein the foam includes, as pneumatagen, a gas.

18. A pad according to any preceding claim, wherein the heat sensitive adhesive melts at a temperature of from 70° C. to 300° C., preferably from 90° C. to 250° C.

19. A pad according to any preceding claim, wherein the softening temperature of the heat sensitive adhesive is 10° C. or greater, preferably 20° C. or greater, than the washing temperature.

20. A pad according to any preceding claim, wherein the softening temperature of the heat sensitive adhesive is 40° C. or greater, preferably 50° C. or greater, 60° C. or greater, 70° C. or greater, 80° C. or greater, 90° C. or greater or 100° C. or greater.

21. A pad according to any preceding claim, wherein the heat sensitive adhesive comprises a polyamide, a polyolefin, a polyurethane or a mixture thereof.

22. A pad according to claim 21, wherein the heat sensitive adhesive comprises a polyether based polyurethane, a polyester based polyurethane or a mixture thereof.

23. A pad according to any preceding claim, wherein the layer of heat sensitive adhesive is bonded to the body during the formation of the body.

24. A pad according to any preceding claim, comprising a flexible material located between the body and the layer of heat sensitive adhesive.

25. A pad according to claim 24, wherein the flexible material is compressible.

26. A pad according to any preceding claim, comprising a polymer layer covering the second surface of the body.

27. A pad according to claim 26, wherein the polymer layer covering the second surface of the body is bonded to the layer of heat sensitive adhesive covering the first surface of the body.

28. A pad according to claim 26 or claim 27, wherein the polymer layer covering the second surface of the body melts at a temperature of from 40° C. to 350° C., preferably from 90° C. to 300° C.

29. A pad according to any of claims 26 to 28, wherein the softening temperature of the polymer layer covering the second surface of the body is 10° C. or greater, preferably 20° C. or greater, than the washing temperature.

30. A pad according to any of claims 26 to 29, wherein the softening temperature of the polymer layer covering the second surface of the body is 40° C. or greater, preferably 50° C. or greater, 60° C. or greater, 70° C. or greater, 80° C. or greater, 90° C. or greater or 100° C. or greater.

31. A pad according to any of claims 26 to 30, wherein the polymer layer covering the second surface of the body comprises one or more materials selected from plastics, elastomeric materials, polyolefins, polyamides, polystyrenes, ethylene-vinyl acetates, nylons, polyesters, polyethylenes, polytetrafluroethylene, silicones, vinyls, polyurethanes, polyvinyl chloride, latex rubbers, synthetic rubbers, thermoplastic elastomers, or mixtures thereof.

32. A pad according to claim 31, wherein the polymer layer covering the second surface of the body comprises a material selected from polyamides, polyolefins, elastomeric materials, polyurethanes, silicones or mixtures thereof.

33. A pad according to claim 32, wherein the polymer layer covering the second surface of the body comprises a polyether based polyurethane, a polyester based polyurethane or a mixture thereof.

34. A pad according to any of claims 26 to 33, wherein the polymer layer covering the second surface of the body includes openings therein.

35. A pad according to any of claims 26 to 34, comprising one or more materials located between the body and the polymer layer covering the second surface of the body.

36. A pad according to claim 35, wherein the one or more materials located between the body and polymer layer covering the second surface of the body are selected from flexible materials, compressible materials, plastics, textiles and metals.

37. A pad according to any of claims 1 to 25, comprising one or more materials attached to the second surface of the body.

38. A pad according to any of claims 26 to 36, comprising one or more materials attached to the outer surface of the polymer layer covering the second surface of the body.

39. A pad according to claim 37 or claim 38, wherein the softening temperature of the one or more materials is 10° C. or greater, preferably 20° C. or greater, than the washing temperature.

40. A pad according to any of claims 37 to 39, wherein the softening temperature of the one or more materials is 40° C. or greater, preferably 50° C. or greater, 60° C. or greater, 70° C. or greater, 80° C. or greater, 90° C. or greater or 100° C. or greater.

41. A pad according to any of claims 37 to 40, wherein the one or more materials are selected from compressible materials, plastics, metals, polyamides and flexible materials, including fabrics.

42. A pad according to any preceding claim, wherein the softening temperatures of the heat sensitive adhesive and of the materials forming all other surfaces of the pad are 10° C. or greater, preferably 20° C. or greater, than the washing temperature.

43. A pad according to any preceding claim, wherein the softening temperatures of the heat sensitive adhesive and of the materials forming all other surfaces of the pad are 40° C. or greater, preferably 50° C. or greater, 60° C. or greater, 70° C. or greater, 80° C. or greater, 90° C. or greater or 100° C. or greater.

44. A pad according to claim 38, wherein the one or more materials attached to the outer surface of the polymer layer covering the second surface of the body includes a fabric, and further wherein the melting temperatures of the heat sensitive adhesive and of the polymer layer covering the second surface of the body are substantially the same.

45. A pad according to any of claims 1 to 43, wherein the melting temperature of the materials forming the surface of the pad opposite the surface to which the heat sensitive adhesive is bonded is at least 20° C. higher, preferably at least 30° C. higher, than the melting temperature of the heat sensitive adhesive.

46. A pad according to any of claims 1 to 25, wherein the melting temperature of the second surface of the body is at least 20° C. higher, preferably at least 30° C. higher, than the melting temperature of the heat sensitive adhesive.

47. A pad according to any of claims 26 to 36, wherein the melting temperature of the polymer layer covering the second surface of the body is at least 20° C. higher, preferably at least 30° C. or higher, than the melting temperature of the heat sensitive adhesive.

48. A pad according to any of claims 37 to 41, wherein the melting temperature of the one or more materials is at least 20° C. higher, preferably at least 30° C. higher, than the melting temperature of the heat sensitive adhesive.

49. A pad according to any preceding claim comprising one or more vents passing through the pad.

50. A pad according to any preceding claim, wherein the body is substantially uniform in thickness.

51. A pad according to any of claims 1 to 49, wherein the body includes two or more regions having different thicknesses.

52. A process for the preparation of a pad according to claim 1, comprising bonding the layer of heat sensitive adhesive to at least the periphery of the first surface of the body.

53. A process according to claim 52, comprising causing the layer of heat sensitive adhesive to become bonded to at least the periphery of the first surface of the body during the formation of the body.

54. A process according to claim 53, comprising disposing a precursor mixture suitable for forming the body in a first mould section, disposing a layer of heat sensitive adhesive over the precursor mixture, disposing a second mould section over the layer of heat sensitive adhesive, and causing the precursor mixture to cure and/or foaming the precursor mixture to form the body.

55. A process according to claim 53, comprising disposing a precursor mixture suitable for forming the body in a first mould section, disposing a flexible material over a portion of the precursor mixture so that at least the periphery of the precursor mixture is not covered by the flexible material, disposing a layer of heat sensitive adhesive over the precursor mixture and the flexible material, disposing a second mould section over the layer of heat sensitive material, and causing the precursor mixture to cure and/or foaming the precursor mixture to form the body.

56. A process according to claim 54 or claim 55, wherein prior to curing/foaming, the precursor mixture suitable for forming the body has a viscosity measured at 20° C. of from to 2800 mPa·s, preferably from 1800 to 2400 mPa·s, and a cream time of from 3 to seconds, preferably from 5 to 7 seconds.

57. A process according to claim 53, comprising disposing a polymer layer in a first mould section, disposing a precursor mixture suitable for forming the body over the polymer layer, disposing a layer of heat sensitive adhesive over the precursor mixture, disposing a second mould section over the layer of heat sensitive adhesive, and causing the precursor mixture to cure and/or foaming the precursor mixture to form the body.

58. A process according to claim 57, wherein prior to curing/foaming, the precursor mixture suitable for forming the body has a viscosity measured at 20° C. of from 1400 to mPa·s, preferably from 1800 to 2400 mPa·s, and a cream time of from 3 to 8 seconds, preferably from 5 to 7 seconds.

59. A process according to any of claims 52 to 56, wherein the elastic energy absorbent material is a composite material as defined in any of claims 2 to 17, and/or the heat sensitive adhesive is a material as defined in any of claims 18 to 22.

60. A process according to claim 57 or claim 58, wherein the elastic absorbent material is a composite material as defined in any of claims 2 to 17, and/or the heat sensitive adhesive is a material as defined in any of claims 18 to 22, and/or the polymer layer is as defined in any of claims 28 to 34.

61. A pad for attachment to a textile by heating, obtainable by a process according to any of claims 52 to 60.

62. A textile article comprising one or more pads according to any of claims 1 to 51 or claim 61 attached to a textile.

63. A textile article according to claim 62, wherein the textile is a woven or non-woven fabric comprising natural and/or artificial materials, preferably spandex or elastane, cordura, aramids, cotton or canvas.

64. A textile article according to claim 62 or claim 63, which is a protective garment, a knee pad or an elbow pad.

65. A process for the preparation of a textile article according to any of claims 62 to 64, comprising placing the layer of heat sensitive adhesive covering the first surface of the body of a pad according to any of claims 1 to 51 or claim 61, in contact with a textile and applying sufficient heat to melt the heat sensitive adhesive and cause the pad to become attached to the textile.

66. A process for the preparation of a textile article according to any of claims 62 to 64, comprising placing a first surface of a layer of heat sensitive adhesive in contact with a textile and placing in contact with the opposing surface of the layer of heat sensitive adhesive a pad comprising a body comprising an elastic, energy absorbent material, which exhibits a resistive load under deformation which increases with the rate of deformation, the body having a first surface and an opposing second surface, and applying sufficient heat to melt the heat sensitive adhesive and cause the pad to become attached to the textile.

67. A process according to claim 66, wherein the body of the pad is as defined in any of claim 2 to 17, 50 or 51 and/or wherein the pad comprises a polymer layer covering the second surface of the body, wherein the polymer layer is as defined in any of claims 28 to 34 and/or the layer of heat sensitive adhesive is as defined in any of claims 18 to 22.

68. A process according to any of claims 65 to 67, comprising bringing the layer of heat sensitive adhesive into contact with a first surface of the textile and bringing a heated surface into contact with the opposing surface of the textile in the region where the heat sensitive adhesive contacts the textile.

69. A process according to any of claims 65 to 68, wherein the textile is as defined in claim 63 and/or the textile article is as defined in claim 64.

70. A textile article obtainable by the process of any of claims 65 to 69.

71. A kit for producing a textile article according to any of claim 62 to 64 or 70, comprising one or more pads according to any of claim 1 to 51 or 61 and a textile.

72. A kit for producing a textile article according to any of claim 62 to 64 or 70, comprising a sheet of heat sensitive adhesive and a pad comprising a body comprising an elastic, energy absorbent material, which exhibits a resistive load under deformation which increases with the rate of deformation, the body having a first surface and an opposing second surface.

73. A kit according to claim 72, wherein the pad comprises a body as defined in any of claim 2 to 17, 50 or 51 and/or the pad comprises a polymer layer covering the second surface of the body, wherein the polymer layer is as defined in any of claims 29 to 34, and/or the layer of heat sensitive adhesive is as defined in any of claims 18 to 22.

74. Use of a pad according to any of claim 1 to 51 or 61 for the preparation of a textile article by attaching the pad to a textile by heating.
